(19) United States
(12) Patent Application Publication
(10) Pub. No.: US 2002/0046357 A1
(43) Pub. Date: Apr. 18, 2002

(54) Software-based fault tolerant networking using a single LAN

(76) Inventors: Jiandong Huang, San Jose, CA (US); Sejun Song, Minneapolis, MN (US); Tony John Kozlik, Phoenix, AZ (US); Ronald J. Freimark, Scottsdale, AZ (US); Jay W. Gustin, Scottsdale, AZ (US); Christopher Lunemann, Jim Thoepe, PA (US); Laurence Arthur Clawson, Cave Creek, AZ (US); John M. Dahl, Grand Forks, ND (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/751,945

(22) Filed: Dec. 29, 2000

Related U.S. Application Data
(63) Continuation-in-part of application No. 09/513,010, filed on Feb. 25, 2000.

(30) Foreign Application Priority Data
Dec. 28, 1999 (EP) 99403307.4

(51) Int. Cl. G06F 11/00

(52) U.S. Cl. 714/4

(57) ABSTRACT

The present invention provides a method of operating a computer network with fault-tolerant nodes, comprising determining the state of a first and second link between fault-tolerant nodes and other network nodes. Data sent by the fault-tolerant node to other nodes may then be sent over a link that is selected based on the state of the first and second links. In some embodiments of the invention this takes place in an intermediate node in a network, which receives data from an originating node and forwards it to a destination node via a link selected based on the state of the first and second links.

In some further embodiments of the invention, fault-tolerant nodes contain network status tables that indicate the ability of the fault tolerant node to receive data from and transmit data to other nodes via each of the links connected to the fault-tolerant nodes.

### CLAIM OF PRIORITY

This application is a Continuation-In-Part of co-pending application Ser. No. 09/513,010, filed Feb. 25, 2000, titled “Multiple Network Fault Tolerance via Redundant Network Control” (Atty. Docket No. 256.044US1, Honeywell docket H16-26156), and claims priority therefrom. Application Ser. No. 09/513,010 is incorporated herein by reference.

### NOTICE OF CO-PENDING APPLICATION

This application is also related to co-pending application Ser. No. 09/522,702, filed Mar. 10, 2000, titled “Non-Fault Tolerant Nodes in a Multiple Fault Tolerant Network (Atty. Docket No. 256.045US1, Honeywell docket H16-26157), which application is incorporated by reference.

### FIELD OF THE INVENTION

The invention relates generally to computer networks, and more specifically to a method and apparatus providing communication between network nodes via one or more intermediate nodes in a fault-tolerant network.

### BACKGROUND OF THE INVENTION

Computer networks have become increasingly important to communication and productivity in environments where computers are utilized for work. Electronic mail has in many situations replaced paper mail and faxes as a means of distribution of information, and the availability of vast amounts of information on the Internet has become an invaluable resource both for many work-related and personal tasks. The ability to exchange data over computer networks also enables sharing of computer resources such as printers in a work environment, and enables centralized network-based management of the networked computers.

For example, an office worker's personal computer may run software that is installed and updated automatically via a network, and that generates data that is printed to a networked printer shared by people in several different offices. The network may be used to inventory the software and hardware installed in each personal computer, greatly simplifying the task of inventory management. Also, the software and hardware configuration of each computer may be managed via the network, making the task of user support easier in a networked environment.

Networked computers also typically are connected to one or more network servers that provide data and resources to the networked computers. For example, a server may store a number of software applications that can be executed by the networked computers, or may store a database of data that can be accessed and utilized by the networked computers. The network servers typically also manage access to certain networked devices such as printers, which can be utilized by any of the networked computers. Also, a server may facilitate exchange of data such as e-mail or other similar services between the networked computers.

Connection from the local network to a larger network such as the Internet can provide greater ability to exchange data, such as by providing Internet e-mail access or access to the World Wide Web. These data connections make conducting business via the Internet practical, and have contributed to the growth in development and use of computer networks. Internet servers that provide data and serve functions such as e-commerce, streaming audio or video, e-mail, or provide other content rely on the operation of local networks as well as the Internet to provide a path between such data servers and client computer systems.

But like other electronic systems, networks are subject to failures. Misconfiguration, broken wires, failed electronic components, and a number of other factors can cause a computer network connection to fail, leading to possible inoperability of the computer network. Such failures can be minimized in critical networking environments such as process control, medical, or other critical applications by utilization of backup or redundant network components. One example is use of a second network connection to critical network nodes providing the same function as the first network connection. But, management of the network connections to facilitate operation in the event of a network failure can be a difficult task, and is itself subject to the ability of a network system or user to properly detect and compensate for the network fault. Furthermore, when both a primary and redundant network develop faults, exclusive use of either network will not provide full network operability.

One solution is use of a method or apparatus that can detect and manage the state of a network of computers utilizing redundant communication channels. Such a system incorporates in various embodiments nodes which are capable of detecting and managing the state of communication channels between the node and each other fault-tolerant network node to which it is connected. In some embodiments, such network nodes employ a network status data record indicating the state of each of a primary and redundant network connection to each other node, and further employ logic enabling determination of an operable data path to send and receive data between each pair of nodes.

But, such networks will desirably include nodes which do not have full fault-tolerant capability. One common example of such a non-fault-tolerant network node is a standard office laser printer with a built-in network connection. What is needed is a method and apparatus to facilitate communication with both non-fault-tolerant and fault-tolerant network nodes in a fault-tolerant network system.

### SUMMARY OF THE INVENTION

The present invention provides a method of operating a computer network with fault-tolerant nodes, comprising determining the state of a first and second link between fault-tolerant nodes and other network nodes. Data sent by the fault-tolerant node to other nodes may then be sent over a link that is selected based on the state of the first and second links. In some embodiments of the invention this takes place in an intermediate node in a network, which receives data from an originating node and forwards it to a destination node via a link selected based on the state of the first and second links.

In some further embodiments of the invention, fault-tolerant nodes contain network status tables that indicate the ability of the fault tolerant node to receive data from and transmit data to other nodes via each of the links connected to the fault-tolerant nodes.

### BRIEF DESCRIPTION OF THE FIGURES

FIG. 1 shows a diagram of a network having fault-tolerant nodes as may be used to practice the present invention.

FIG. 2 shows a network status table, consistent with an embodiment of the present invention.

FIG. 3 is a flowchart of a method of operating a network having fault-tolerant intermediate nodes, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides a method and apparatus for managing communication with non-fault-tolerant network nodes and fault-tolerant nodes in a fault-tolerant network by using intermediate nodes to route network data around network faults. The network in some embodiments comprises both fault-tolerant and non-fault tolerant nodes, and can route data between nodes using fault-tolerant nodes as intermediate nodes that are capable of routing data around network faults.

The invention in various forms is implemented within an existing network interface technology, such as Ethernet. In one such embodiment, two Ethernet connections are connected to each fault-tolerant computer or node. It is not critical for purposes of the invention to distinguish the connections from one another, as the connections are physically and functionally similar. The network with fault-tolerant intermediate nodes as described herein may also contain a number of non-fault tolerant nodes that may originate or receive data by using the fault-tolerant nodes as intermediate nodes, which are capable of routing data around network faults as described herein.

FIG. 1 shows a example network comprising a non-fault tolerant node 101, switches 102 and 103, and fault-tolerant nodes 104, 105 and 106. The two switches 102 and 103 are further linked by intra LAN bridge connection 110. These seven elements make up a local area network that is further connected to a network 107, which is connected to a file server 108 and a printer 109. The non-fault tolerant node 101 may be a printer, computer, or other device in a fault-tolerant network that does not support fault tolerance via multiple network connections.

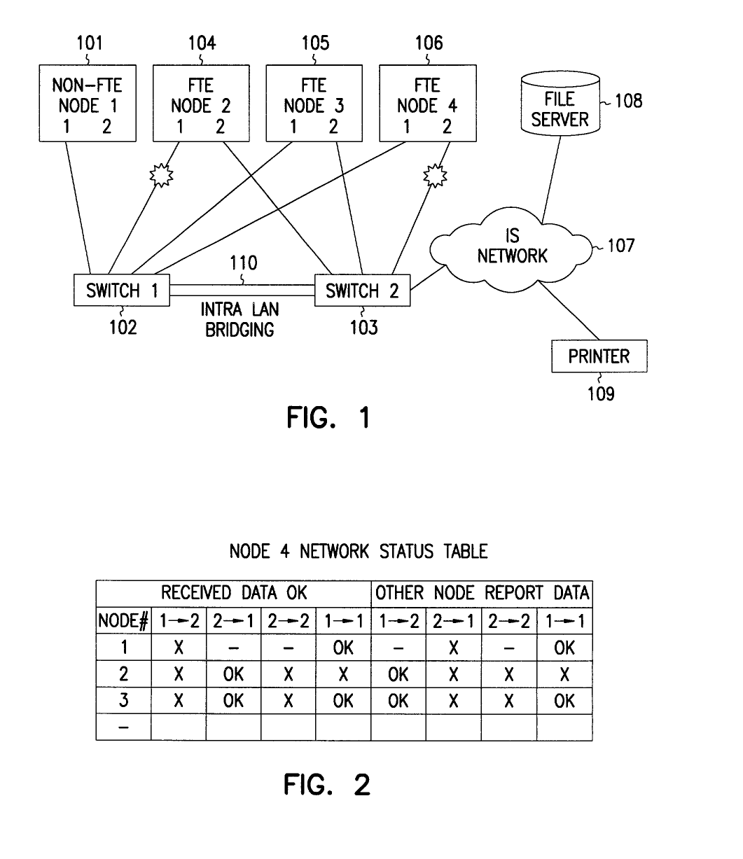

Each of the fault-tolerant nodes 104, 105 and 106 will store network status data such as via the network status table as is shown in FIG. 2. From the data in the network status tables such as the network status table of FIG. 2, the state of the various network connections can be determined and a suitable connection for communication between each pair of network nodes can be selected. The network status table in FIG. 2 reflects network status data for node 4 of the example network shown in FIG. 1, and indicates the condition of communication links between node 4 and other nodes in the network.

The data in the “Received Data OK” columns reflects whether node 4 can successfully receive data from each of the other nodes in the network over each of links 1 and 2 for both nodes. An “X” in the table indicates data is not received, an “OK” indicates data is received, and a “-” indicates that such a link does not exist. Also, each column indicates which links the data travels over, such that from link 2 of the sending node to link 1 of the receiving node would be designated “2→1”. For example, the “X” in the “Received Data OK” table under Node 1, “1→2” indicates that data leaving node 1 via link 1 and entering node 4 via link 2 cannot be received. Also, the dashes under Node 1 in both the “2→1” and the “2→2” are a result of there not being a link 2 in node 1. Finally, the “OK” under Node 1, “1→1” indicates that communication from node 1, link 1 to node 4, link 1 is OK.

This example embodiment of the invention also has an “Other Node Report Data” table section that essentially restates the data in the “Received Data OK” section of the table in different terms. The “Other Node Report Data” section reflects data as reported by other nodes, as the data exists in the other nodes' “Received Data OK” tables. However, the data reported by the other nodes is in this example also fully reflected in the “Received Data OK” section of the table for node 4. For example, the “Other Node Report Data” for node 1 indicates the same data as is recorded in the “Received Data OK” section of the same table, with the links reversed because the data is from the perspective of and provided by node 1.

In some embodiments of the invention where links may be able to send but not receive or may receive but not send data, the contents of the “Other Node Report Data” table may differ from the “Received Data OK” table, as data may be able to travel in one direction via a certain pair of links but not in the opposite direction. Such embodiments benefit greatly from having both “Received Data OK” data and “Other Node Report Data”, and are within the scope of the invention.

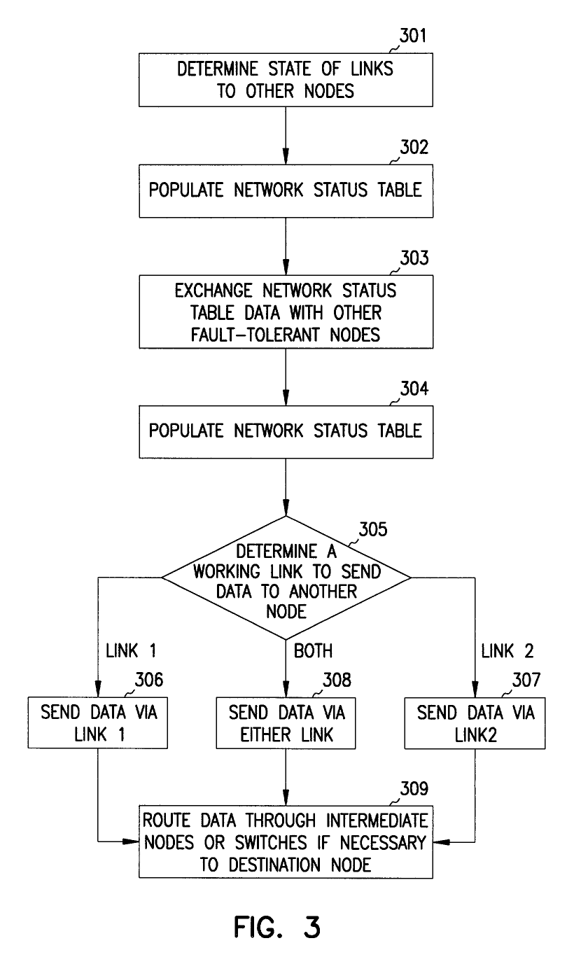

Using this Network Status Table data, each node can route data around many network faults and communicate despite multiple failed links. FIG. 3 is a flowchart of a method that illustrates how the network status table may be employed in practicing the present invention. At 301, the node desiring to send data determines the state of its network connection to other nodes. At 302, the node uses the data regarding the state of its network connections to other nodes to populate the “Received Data OK” portion of its network status table. The node then exchanges this data with other nodes at 303, and populates the “Other Node Report Data” portion of its network status table at 304.

The determination of whether a node can receive data from another node is made in various embodiments using special-purpose diagnostic data signals, using network protocol signals, or using any other suitable type of data sent between nodes. The data each node provides to other nodes to populate the “Other Node Report Data” must necessarily be data which includes the data to be communicated between nodes, and is in one embodiment a special-purpose diagnostic data signal comprising the node data to be reported.

At 305, the fault-tolerant node determines which of its links are operable to send data to the intended node. If only a first link is operable, data is sent via the first link at 306. If only a second link is operable, data is sent via the second link at 307. Typically, both links will be operable, and the data may be sent via either link, chosen by any appropriate method such as by availability or at random, at 308.

Finally, the data is sent via the selected link, and may be routed through intermediate nodes or switches to reach its ultimate destination if the network topology so requires. The intermediate nodes or switches may in various embodiments of the invention be routers or bridges, or any other device able to provide a similar function within the network.

As an example, suppose that node 4 of FIG. 1 shown at 106 desires to send data to node 1 at 101. The network status table has been populated as is shown in FIG. 2 by evaluating which nodes can receive data from which other nodes, and exchanging this data among nodes. At 305, it is determined by looking at the “Other Node Report Data” section of the network status table of FIG. 2 that there is not a second link connected to node 1, and that data sent from link 2 of node 4 does not reach node 1. The table does reflect that data sent from link 1 of node 1 reaches node 4, and so the data is sent via link 1 at 306. At 309, the data is routed through switch 1 shown at 102 of FIG. 1 to node 1, where it is received via its only link, link 1.

The present invention provides a method and apparatus for managing communication between non-fault-tolerant network nodes and fault-tolerant nodes in a fault-tolerant network by using a network status table to route network data around network faults, including the use of intermediate network nodes. The network in some embodiments comprises both fault-tolerant and non-fault tolerant nodes, and can route data between nodes using fault-tolerant intermediate nodes or switches that are capable of routing data around network faults.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A method of managing the state of a computer network comprising fault-tolerant network nodes, comprising:
determining the state of a first link between fault-tolerant nodes and other network nodes;
determining the state of a second link between fault-tolerant nodes and other network nodes;
receiving data from an originating node in a first fault-tolerant intermediate node; and
selecting either the first link or the second link from the first fault-tolerant intermediate node to a destination node for sending data, such that the link is selected based on the network states determined independently for each fault-tolerant node.

2. The method of claim 1, wherein the destination node is a fault-tolerant intermediate node.

3. The method of claim 1, wherein the originating node is a non-fault tolerant node.

4. The method of claim 1, wherein the first fault-tolerant intermediate node is a switch.

5. The method of claim 1, further comprising building an independent network status table in each fault-tolerant node that indicates results of determining the state of the first and second link between that node and other network nodes.

6. The method of claim 5, wherein the network status table comprises data representing network status based on data received at a fault-tolerant network node from other network nodes.

7. The method of claim 6, wherein the data received at a fault-tolerant network node from other networked nodes comprises a diagnostic message.

8. The method of claim 6, wherein data received at a fault-tolerant network node from other networked nodes comprises data representing the ability of the other fault-tolerant nodes to receive data from other different network nodes.

9. The method of claim 5, wherein the network status table comprises data representing network status based on a fault-tolerant node's ability to send data to other nodes.

10. The method of claim 6, wherein the network status table further comprises data representing network status based on a fault-tolerant node's ability to send data to other nodes.

11. The method of claim 1, wherein determining the state of a first and second link from fault-tolerant nodes comprises determining whether each node connected to a fault-tolerant node can send data to the fault-tolerant node and can receive data from the fault-tolerant node over each of the first and second links.

12. A fault-tolerant computer network interface, the interface operable to:
determine the state of a first link between the interface and other network nodes;
determine the state of a second link between the interface and other network nodes;
receive data from an originating node; and
select either the first link or the second link from the interface to a destination node for sending data, such that the link is selected based on the determined state of each link.

13. The fault-tolerant computer network interface of claim 12, wherein the destination node is a fault-tolerant intermediate node.

14. The fault-tolerant computer network interface of claim 12, wherein the originating node is a non-fault tolerant node.

15. The fault-tolerant computer network interface of claim 12, wherein the computer network interface comprises part of a switch.

16. The fault-tolerant computer network interface of claim 12, the interface further operable to build a network status table that indicates results of determining the state of the first and second link between the interface and other network nodes.

17. The fault-tolerant computer network interface of claim 16, wherein the network status table comprises data representing network status based on data received at the interface from other network nodes.

18. The fault-tolerant computer network interface of claim 17, wherein the data received at the interface from other networked nodes comprises a diagnostic message.

19. The fault-tolerant computer network interface of claim 17, wherein the data received at the interface from other network nodes comprises data representing the ability of the other fault-tolerant nodes to receive data from other different network nodes.

20. The fault-tolerant computer network interface of claim 16, wherein the network status table comprises data representing network status based on the interface's ability to send data to other nodes.

21. The fault-tolerant computer network interface of claim 17, wherein the network status table further comprises data representing network status based on the interface's ability to send data to other nodes.

22. The fault-tolerant computer network interface of claim 12, wherein determining the state of a first and second link from the interface comprises determining whether each node connected to the interface can send data to the interface and can receive data from the interface over each of the first and second links.

23. A machine-readable medium with instructions thereon, the instructions when executed operable to cause a computerized system operating as a fault-tolerant node in a network to:
determine the state of a first link between the computerized system and other network nodes;
determine the state of a second link between the computerized system and other network nodes;
receive data from an originating node; and
select either the first link or the second link from the computerized system to a destination node for sending data, such that the link is selected based on the determined state of each link.

24. The machine-readable medium of claim 23, wherein the destination node is a fault-tolerant intermediate node.

25. The machine-readable medium of claim 23, wherein the originating node is a non-fault tolerant node.

26. The machine-readable medium of claim 23, wherein the computerized system is a switch.

27. The machine-readable medium of claim 23, the instructions when executed further operable to cause the computerized system to build a network status table that indicates results of determining the state of the first and second link between the computerized system and other network nodes.

28. The machine-readable medium of claim 27, wherein the network status table comprises data representing network status based on data received at the computerized system from other network nodes.

29. The machine-readable medium of claim 28, wherein the data received at the computerized system from other networked nodes comprises a diagnostic message.

30. The machine-readable medium of claim 28, wherein the data received at the computerized system from other network nodes comprises data representing the ability of the other fault-tolerant nodes to receive data from other different network nodes.

31. The machine-readable medium of claim 27, wherein the network status table comprises data representing network status based on the computerized system's ability to send data to other nodes.

32. The machine-readable medium of claim 28, wherein the network status table further comprises data representing network status based on the computerized system's ability to send data to other nodes.

33. The machine-readable medium of claim 23, wherein determining the state of a first and second link from the computerized system comprises determining whether each node connected to the computerized system can send data to the system and can receive data from the system over each of the first and second links.
